(19) United States
(12) Patent Application Publication
(10) Pub. No.: US 2025/0111049 A1
(43) Pub. Date: Apr. 3, 2025

(54) ZERO-SHOT BLACK-BOX DETECTION OF NEURAL TROJANS

(71) Applicant: Qatar Foundation for Education, Science and Community Development, Doha (QA)

(72) Inventors: Issa M. Khalil, Doha (QA); Ting Yu, Doha (QA); Dorde Popovic, Doha (QA); Mohammad Amin Sadeghi, Doha (QA); Sanjay Chawla, Doha (QA)

(21) Appl. No.: 18/903,354

(22) Filed: Oct. 1, 2024

Related U.S. Application Data
(60) Provisional application No. 63/542,136, filed on Oct. 3, 2023.

(51) Int. Cl. G06F 21/56

(52) U.S. Cl. CPC G06F 21/56

(57) ABSTRACT

Example systems, methods, and apparatus are disclosed herein for zero-shot black-box detection of neural Trojans.

### RELATED APPLICATIONS

The present disclosure claims priority to U.S. Provisional Patent Application 63/542,136 having a filing date of Oct. 3, 2023, the entirety of which is incorporated herein.

### BACKGROUND

Trojan attacks are among the most effective, stealthy, and practical attacks in deep learning. Their detection is challenging because in a realistic attack scenario: (1) the defender is seeing the model and the attack for the first time (Zero-shot), and (2) the defender cannot necessarily examine the internal processes of the model (Black-box). The proposed technology includes a technique for neural Trojan detection that operates under these realistic restrictions. The proposed technology generates Trojan triggers by optimizing an objective function, and accounts for cases where the optimization search space is combinatorial. The proposed technology is evaluated against the state-of-the-art by considering three established baselines. Even though these techniques are not restricted to Zero-shot and Black-box settings, the proposed technology outperforms all of them in detection as well as trigger synthesis and target label prediction. Since the proposed technology does not rely on training data, it is architecture agnostic and generalizes well to different types of Trojan attacks.

### SUMMARY

Example systems, methods, and apparatus are disclosed herein for zero-shot black-box detection of neural Trojans.

In light of the disclosure herein, and without limiting the scope of the invention in any way, in a first aspect of the present disclosure, which may be combined with any other aspect listed herein unless specified otherwise, a system for zero-shot black-box detection of neural Trojans.

In a second aspect of the present disclosure, which may be combined with any other aspect listed herein unless specified otherwise, a method of zero-shot black-box detection of neural Trojans.

In a third aspect of the present disclosure, any of the structure, functionality, and alternatives disclosed in connection with any one or more of FIGS. 1 to 6 may be combined with any other structure, functionality, and alternatives disclosed in connection with any other one or more of FIGS. 1 to 6.

In light of the present disclosure and the above aspects, it is therefore an advantage of the present disclosure to provide users with zero-shot black-box detection of neural Trojans.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIGS. 1A-C shows examples of patch and blended attacks on a clean image of a traffic sign, according to an example embodiment of the present disclosure.

FIG. 2 is a graph showing: (left) an overview of a generative process for optimizing a patch trigger to achieve the highest continuous attack success rate (cASR), (right) the relationship between the attack success rate (ASR) and an approximated continuous attack success rate (cASR), according to an example embodiment of the present disclosure.

FIGS. 3A-C are graph comparisons of performance across the three tasks in the NeurIPS 2022 Trojan Detection Challenge, according to an example embodiment of the present disclosure.

FIG. 4 is a graph of a breakdown of the continuous attack success rate (cASR) detection scores across different attack types and datasets, according to an example embodiment of the present disclosure.

FIGS. 5A-B are heatmaps of patch triggers synthesized for clean CNNs trained on MNIST and a heatmap of patch triggers synthesized for Trojan CNNs train on MNIST 505, according to an example embodiment of the present disclosure.

FIGS. 6A-C are graphs of an analysis of the impact of clean image validation batch size (b), number of executed optimization steps (s), and cASR approximation parameter (λ) on the proposed technique's detection performance, according to an example embodiment of the present disclosure.

### DETAILED DESCRIPTION

Methods, systems, and apparatus are disclosed herein for zero-shot black-box detection of neural Trojans.

While the example methods, apparatus, and systems are disclosed herein for zero-shot black-box detection of neural Trojans, it should be appreciated that the methods, apparatus, and systems may be operable for other applications.

Deep Learning is becoming an integral component of security-critical applications such as self-driving cars, medical diagnostics, and financial crime detection systems. It is shown that these deep models are vulnerable to security attacks. Among these attacks, neural Trojan attacks are especially stealthy and effective. There are a few factors that make a neural Trojan hard to detect:
1. Trigger secrecy: An effective Trojan model exhibits malicious behavior if and only if the trigger is present in the input. The trigger should be stealthy; it should be secretly held by the attacker and difficult to guess by the defender. Therefore, effective triggers often have a combinatorial search space.
2. Opacity of deep models: An effective Trojan attack hides the trigger functionality within the weights of a deep model. The weights of a stealthy Trojan model can be statistically indistinguishable from that of a clean model.
3. Black-box: In many realistic defense settings, the victim obtains an executable piece of software that only allows input/output interaction with the model. The weights, gradients, and any other information about the model is hidden from the defender inside of a black-box.
4. Zero-shot: In realistic scenarios, the victim obtains a single model from an untrusted party and doesn't have insight into the attack or a clean version of the model to compare against.

However, most existing defense techniques assume the attack lacks some of these strengths, as shown in Table 1 below.

TABLE 1
A comparison of defense assumptions between our technique and prior work. Note that
TDC 2022 refers to the setting of the Trojan Detection Challenge rather than a single technique.

| Detection Technique | Trigger Secrecy | Opacity of Deep Model | Black-box | Zero-shot |
|---|---|---|---|---|
| SentiNet [8] | [symbol] | [symbol] | [symbol] | ✓ |
| NNoculation [9] | [symbol] | ✓ | [symbol] | ✓ |
| STRIP [11] | [symbol] | ✓ | ✓ | ✓ |
| DF-TND [13] | ✓ | [symbol] | [symbol] | ✓ |
| ULP [16] | ✓ | ✓ | ✓ | [symbol] |
| ABS [12] | ✓ | [symbol] | [symbol] | ✓ |
| NeuralCleanse [15] | ✓ | ✓ | [symbol] | ✓ |
| MNTD [18] | ✓ | ✓ | ✓ | [symbol] |
| TDC 2022 [19] | ✓ | ✓ | [symbol] | [symbol] |
| Our Technique | ✓ | ✓ | ✓ | ✓ |

Some defense techniques detect Trojan models only after they encounter a Trojan input. This breaks the trigger secrecy criteria. As a result, the defender cannot verify a model before it is used in practice and subjected to an attack.

Some defense techniques assume that the deep model learns the trigger as a feature, and that this feature is reflected in a few Trojan neurons. This neglects the opacity of deep models as it makes strong assumptions about the model's inner processes.

Some defense techniques use operations such as differentiation, neuron stimulation, and statistical analysis of hidden activations. These operations are practical if the model is open-source. However, these operations are infeasible in a black-box setting (e.g., model is shipped as a closed-source executable).

Some defense techniques assume that a dataset of many clean and Trojan versions of a model exists, and that one can train a Trojan detection model using this dataset. This is also impractical because the model is often being seen for the first time (zero-shot), no alternative set of weights exists to learn from, and crafting such a set requires making strong assumptions about the attack.

The proposed technology includes Trojan detection technique that operates under the assumption that the attacker has all four of the aforementioned strengths. The proposed technology does not rely on seeing Trojan inputs. It does not make assumptions about the inner workings of the model. It does not use any operations that require white-box access to the model. It does not depend on having access to a reference set of clean and Trojan versions of the model.

Given a model, the proposed technology tries to generate the most effective Trojan trigger. In this generative process, it iteratively optimizes a Trojan trigger with respect to a score that approximates attack success. In testing, an explicitly generated Trojan trigger, can answer multiple questions about an inspected model, such as: whether or not the model is Trojan, what the trigger looks like, and what the attack is intended to do.

Since the proposed technology operates in black-box and zero-shot settings, it works on a range of datasets and attack types out of the box. Evaluating the proposed technology on two types of Trojan attacks, three model architectures, and four datasets demonstrates this. There is a comparison of the proposed technology against three baseline techniques and all submissions made to the NeurIPS 2022 Trojan Detection Challenge (TDC). Based on comparison to the submissions to this challenge, two restrictions are imposed on the proposed technology: (1) zero-shot and black-box settings, and (2) use of only a single piece of detection code for all attack types and datasets. Despite these restrictions, the proposed technology outperforms all other techniques in the tasks of detection, target label prediction, and trigger synthesis.

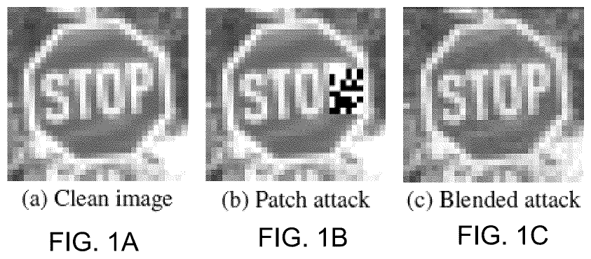

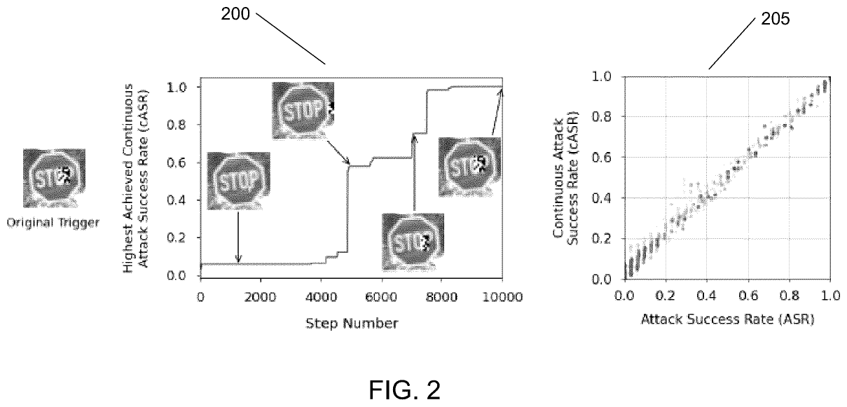

As an example of the types of attacks, FIG. 1 shows examples of patch and blended attacks on a clean image of a traffic sign. FIG. 2 shows an overview of the proposed technology's generative process for optimizing a patch trigger to achieve the highest continuous attack success rate (cASR) 200. The proposed technology starts with a patch with random pattern, size, shape, and location. Through simulated annealing, the pattern, size, shape, and location gradually evolve and become more similar to the original trigger. FIG. 2 also shows the relationship between the attack success rate (ASR) and approximated continuous attack success rate (cASR) 205. Pearson's correlation coefficient r=0.9998. Note that while cASR is continuous, it also closely approximates ASR.

The proposed technology uses the general definition of a neural Trojan attack presented in Neural Cleanse.

$$𝒯 ( x , δ = ( p , m , t ) ) = {x}^{′} \qquad ( 1 )$$

$${x}_{i , j , c}^{′} = ( 1 - {m}_{i , j} ) \cdot {x}_{i , j , c} + {m}_{i , j} \cdot {p}_{i , j , c}$$

Where Tis the Trojan function that applies trigger δ to clean image x, producing the Trojan image x′ that the Trojan model will misclassify to target label t. p is a 3D matrix containing the pixel intensity values representing the trigger pattern and matching the same dimensions as the input image (width, height, and number of color channels). m is a 2D matrix containing values between 0.0-1.0 that determine which pixels in the clean image are overwritten by the trigger pattern (i.e., the trigger's location, shape, and size). m matches the width and height dimensions of the input image.

### Threat Model

Attacker goals and capabilities: The attacker aims to inject a Trojan backdoor into a model and provide this Trojan model to an end-user (e.g., via an MLaaS platform such as Azure, Google Cloud, or Tensorflow). Given clean inputs, the Trojan model should exhibit indistinguishable accuracy from an equivalent clean model. However, if the trigger δ is present in the input, then the Trojan model is supposed to misclassify the input to a pre-defined target label t with high probability (≥95%).

The attacker uses patch and blended attack strategies, as seen in FIG. 1. For patch attacks, the trigger is a continuous patch of pixels that is stamped onto the original image and may have arbitrary pattern, location, size, and target label. For blended attacks, the trigger is blended into the background of the entire original image and may have arbitrary pattern and target label. The proposed technology is agnostic to the attack methodology, whether it involves data poisoning, parameter manipulation, or other methods.

Defender goals and capabilities: The defender's primary goal is to inspect a single model obtained from an untrusted party and make a binary decision on whether the model is clean or Trojan. For Trojan models, the defender aims to predict the attacker's target label t, and synthesize the trigger δ.

To provide a practical detection technique, the proposed technology assumes the defender has (1) no access to Trojan inputs, (2) no assumptions on the processes within the model, (3) only black-box access to model with unlimited queries, and (4) no access to clean or Trojan versions of the model.

The defender can be a non-expert user incapable of retraining the model or training new models. The defender is concerned about patch and blended attacks and has no auxiliary information on the attack. Lastly, the defender possesses a small batch of clean inputs (e.g., 32) to validate model performance.

### Method

The goal of the proposed technology is to generate a Trojan trigger that works. Since the proposed technology operates under a zero-shot setting, it assumes that no clean or Trojan models are available for training. Therefore, the proposed technology performs optimization at inference time rather than training a model on training data.

As discussed previously, a distinctive characteristic of Trojans is that they have a high Attack Success Rate (ASR). The proposed technology exploits this characteristic as an objective to generate triggers. It looks for a Trojan trigger that maximizes ASR. For a given Trojan, ASR measures the percentage of examples that the model successfully misclassifies to the attacker's target label following the application of the trigger. ASR is a discrete metric and is therefore hard to optimize. To overcome this, the proposed technology uses a proxy version of ASR which is continuous (cASR).

To optimize the cASR, the proposed technology begins with a random trigger and progressively modifies it through iterative steps to increase cASR. As the proposed technology operates in a black-box setting, computing the gradients of the inspected model is not feasible, which restricts us from employing gradient descent for optimization purposes.

For certain attacks, such as patch attacks, the state space involved is discrete. Consequently, optimizing these attacks entails searching within a discrete space dictated by the specific attack type. The specifics of the state space and its connectivity are thoroughly examined below. To navigate this space effectively, various algorithms can be employed. The proposed technology utilizes the simulated annealing algorithm primarily because it can operate within non-convex spaces and is guaranteed to converge. In this framework, the choices of scoring function, search space connectivity, and search technique are independent. This helps with the versatility of the proposed technology.

### Objective Function

Given a Trojan model f, a trigger δ, and a clean dataset D, attack success rate (ASR) is defined as:

$$A S R = \frac{\vert \{ x ∈ 𝒟 \vert f ( 𝒯 ( x , δ ) ) = t \} \vert}{\vert 𝒟 \vert} \qquad ( 2 )$$

where T is the Trojan function that applies trigger δ to a clean image, and t is the attacker-chosen target label. The ASR quantifies how often the trigger works, and it is thus the attacker's goal to maximize this efficacy metric, with most works requiring an ASR≥95%. This high ASR defines a Trojan trigger because random perturbations have low ASR. Therefore, to detect the potential presence of a Trojan, it is logical to generate a trigger that maximizes the ASR. However, there exist two major challenges to directly using ASR.

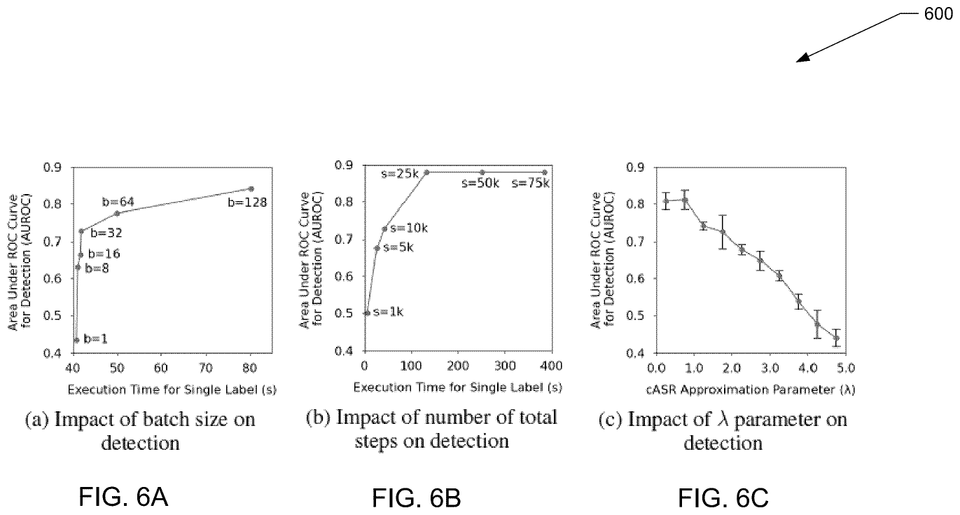

First, the defender may not have access to an entire dataset to evaluate ASR. Even if this was the case, repeatedly computing ASR at each step of optimization is overly expensive for the defender. To avoid the issues of limited data access and high costs, the proposed technology evaluates ASR on a small subset of dataset inputs. In practice, a batch of 32 validation images is sufficient FIG. 6A.

Second, as presented in Equation 2, ASR is a fractional and discrete metric that is hard to optimize. The proposed technology overcomes this challenge by using a continuous proxy to the ASR, which is referred to as the cASR.

Let f(x) be the softmax output of a classifier with 1 labels. The ith label's output is denoted as fi(x). f(x) has been attacked using the Trojan function T that uses trigger δ and targets label t. Let Δ(x)=ft(T(x, δ))−max({fi(T(x, δ))|i/=t}). Then

$$c A S R = \frac{1}{b} {\sum }_{x} \{ \frac{1}{1 + {e}^{λ \cdot Δ ( x )}} \} . \qquad ( 3 )$$

If λ=∞ and b=|D|, then cASR will be equal to ASR. If λ=0, then cASR=0.5. In practice, with a good choice of λ, cASR approximates ASR with a Pearson correlation of 0.9998 and is continuous. FIG. 2 illustrates this approximation.

### Optimization

Search space: A Trojan trigger δ=(p, m, t) can be defined by a pattern p, a mask m, and a target label t. Sample Trojan triggers are shown in FIG. 1. Pattern p and mask m are defined by Trojan type. Target label t determines which label should be classified in the presence of the trigger.

Search for target label: the proposed technology needs to jointly search for pattern p, mask m, and target label t. It turns out that the optimum choice for p and m highly depends on the target label t; because the score of multiple categories cannot be high simultaneously. Since the search space for a label is highly non-convex, the proposed technology performs an exhaustive search over the target label t.

Algorithm 1 Trojan Trigger Generation Using Simulated Annealing

| | |
|---|---|
| 1: | X ← random Trigger( ) |
| 2: | for k = 1, . . . , s do |
| 3: | $T ← ϵ \cdot ( \frac{1}{\text{?} + \text{?}} - \frac{1}{\text{?} + \text{?}} )$ $\text{?} \text{indicates text missing or illegible when filed}$ |
| 4: | X_{new} ← randomNeighbor(X) |
| 5: | C_{old} ← cASR(X) |
| 6: | C_{new} ← cASR(X_{new}) |
| 7: | Δ_{C} ← C_{new} − C_{old} |
| 8: | if Δ_{C} > 0 then |
| 9: | X ← X_{new} |
| 10: | $else if {e}^{\frac{{Δ}_{C}}{T}} \geq random ( 0 , 1 ) then$ |
| 11: | X ← X_{new} |
| 12: | end if |
| 13: | end for |

Simulated annealing: Given a target category, the proposed technology uses simulated annealing to search for the optimum pattern p and mask m. It starts with a random initialization of p and m. Then the proposed technology iteratively changes p and m according to the rules of simulated annealing.

Search for pattern and mask: the proposed technology simulated annealing-based search progresses in steps, and a single potential move is considered at each step. The proposed technology search uses two move strategies. The first is a move that changes the trigger pattern via the alteration of entries in p. The other is a move that changes the mask via the alteration of entries in m.

Temperature: At each step, the moves are generated randomly. If a move increases the scoring function's output, it is applied. However, if a move does not improve or worsens the scoring function's output, it is still applied with a probability known as the temperature T.

$$T = ϵ \cdot ( \frac{1}{k + ϵ} - \frac{1}{s + ϵ} ) \qquad ( 4 )$$

Where s is the total number of steps, k is the current step, and e is a parameter that controls how quickly the temperature drops. Simulated annealing achieves a trade-off between early exploration and later exploitation by leveraging the temperature cooling schedule defined in equation 4. Early in the search, k is low and therefore T is high, meaning the search is likely to make suboptimal moves and therefore explore the search space. As the search progresses and k increases, T drops and thus the search prioritizes making fewer mistakes and optimizing the best trigger.

Versatility: The modular design of the proposed technology framework allows for modifications to be made and applied easily. Each of the proposed technology framework modules (search space, search technique, and scoring function) can be modified or replaced to better fit a new problem. The proposed technology leveraged this modular design to optimize and select each component for the an experimental problem during experimentation.

Different attack types: the proposed technology framework works for both patch and blended Trojan attacks. For patch attacks, the mask m is composed of discrete values 0.0 or 1.0, while for blended attacks, m is composed of continuous values within 0.0-1.0.

Branch-and-Bound: Since it is needed to jointly optimize pattern p and mask m, the proposed technology uses odd iterations to search for p and even iterations to search for m. It changes p one pixel at a time, while to change m, it either extends/contracts the patch by one row/column or move the patch to another random location on the image. For blended attacks, even iterations do not make any changes.

### Advantages of Simulated Annealing

Several properties make simulated annealing an optimal choice for this problem: Black-box: Gradient descent-based optimization algorithms heavily rely on gradient calculations. However, in the proposed technology, calculating gradients is not feasible due to the black-box nature of the proposed technology (e.g., the model may be distributed as a closed-source executable). As a result, first-order optimization techniques are not applicable, and the proposed technology must instead rely on zero-order optimization algorithms.

TABLE 2
Experimental parameters

| Parameter | Values |
|---|---|
| Batch size (b) | {1, 8, 16, 32, 64, 128} |
| Optimization steps (s) | {1 k, 5 k, 10 k, 25 k, 50 k, 75 k} |
| CASR approximation (λ) | {0.1, 0.6, 1,1, 1.6, 2.1, 2,6, 3.1, 3,6, 4.1, 4.6} |

Zero-shot: Simulated annealing does not require learning, so it is data-efficient and applicable in zero-shot settings where training data is unavailable before examining a model.

Discreteness: The search space includes pattern p, mask m, and target label t that can be discrete. Simulated annealing is applicable to discrete optimizations.

Non-convex nature of the optimization: The state-space of pattern p can be non-convex and combinatorial. Simulated annealing can operate for combinatorial problems. The temperature schedule in simulated annealing allows to trade-off exploration vs. exploitation during different stages of optimization.

Convergence guarantees: Mathematical results guarantee the convergence of simulated annealing.

Sampling guarantees: It is shown that simulated annealing is an extension of the Metropolis-Hastings sampling algorithm. Thus, by extension, it is guaranteed that in the long run it samples from a probability distribution of successful triggers.

Controllable running time: The running time of simulated annealing is controllable through the number of steps. Therefore, it is guaranteed to produce an answer in a predefined time limit.

### Experiments

Setup—To assess the effectiveness of the proposed technology, an evaluation against the current state-of-the-art is conducted. This evaluation involves considering two types of Trojan attacks and comparing them against three widely recognized baselines. Additionally, the proposed technology approach is compared to all of the methodologies submitted to the NeurIPS 2022 Trojan Detection Challenge (TDC). The TDC dataset contains 2000 models. These models include: CNNs trained on MNIST data, Wide ResNets trained on CIFAR-10 and CIFAR-100 data, and Vision Transformers trained on GTSRB data (see Table 3, Table 4, and Table 5 for information on image datasets and models).

The TDC dataset includes patch and blended Trojan attacks, which are adaptations of the BadNets and whole-image attacks. These adapted Trojan models are trained via fine-tuning from the starting parameters of clean models, alongside regularization with multiple similarity losses that ensure distributions of parameters of clean and Trojan models are highly similar. Additionally, the triggers are diverse and random, with Trojan models trained to have high specificity for their injected trigger.

All experiments were run using an NVIDIA Tesla V100 GPU and 32GB of RAM. All experimental parameters and nominal values are shown in Table 2.

Competition Dataset Experiments—Detection is a binary classification task that processes a set of models and assigns a score to each model that indicates whether the model is clean (low score) or Trojan (high score). The proposed technology performance is evaluated by measuring the area under ROC curve of scores produced for a dataset of 500 clean models, 250 patch-attacked models, and 250 blended-attacked models.

Target label prediction is a multi-class classification task that processes a set of Trojan models and identifies the target label t of each attack. The proposed technology performance is evaluated by measuring the total accuracy of predicted target labels for 250 patch-attacked models and 250 blended-attacked models.

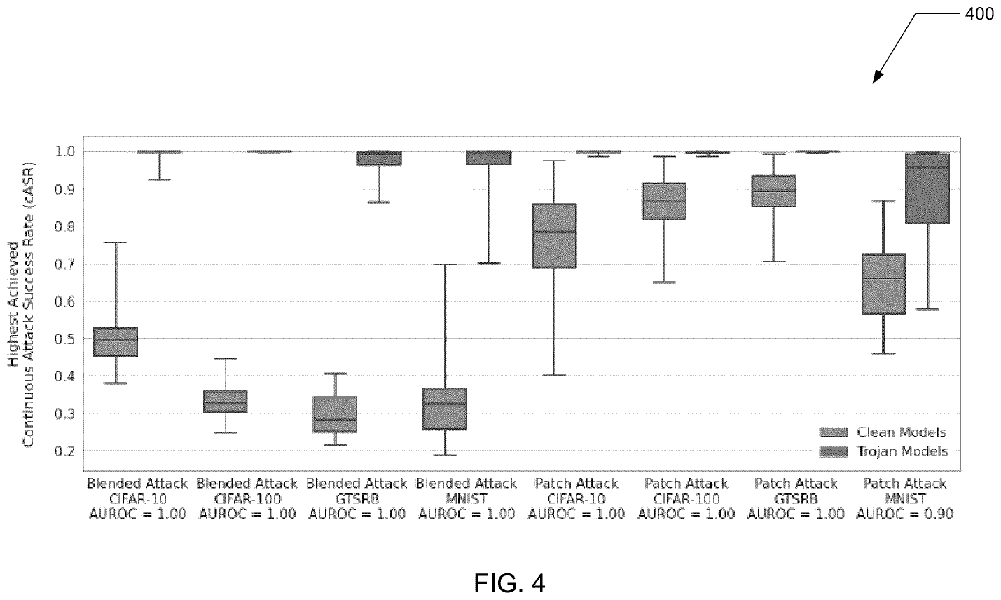

FIG. 4 shows a breakdown of the continuous attack success rate (cASR) detection scores across different attack types and datasets 400. Given each dataset and each task, the proposed technology processes 125 clean models and 62 Trojan models. For 7 out of 8 configurations along the x-axis, the separation is perfect and the area under ROC curve for classification is 1. For the last configuration, the area under ROC curve drops to 0.9. This happens because sometimes, ‘natural Trojan’ triggers exist. This problem is most evident with simple image datasets such as MNIST, where a patch can be easily crafted to intentionally cover and make one digit look like another (e.g., an 8 to a 9). Even though the model performs perfectly for the first 7 configurations, the gap for the blended attacks is larger. This means that blended attacks are generally easier to spot.

Trigger synthesis is a binary segmentation task that processes a set of patch-attacked Trojan models and identifies the trigger mask m (i.e., trigger location, shape, and size) of the attack. The proposed technology performance is evaluated by measuring the intersection over the union between the proposed technology predicted mask and the true trigger mask for 500 patch-attacked models.

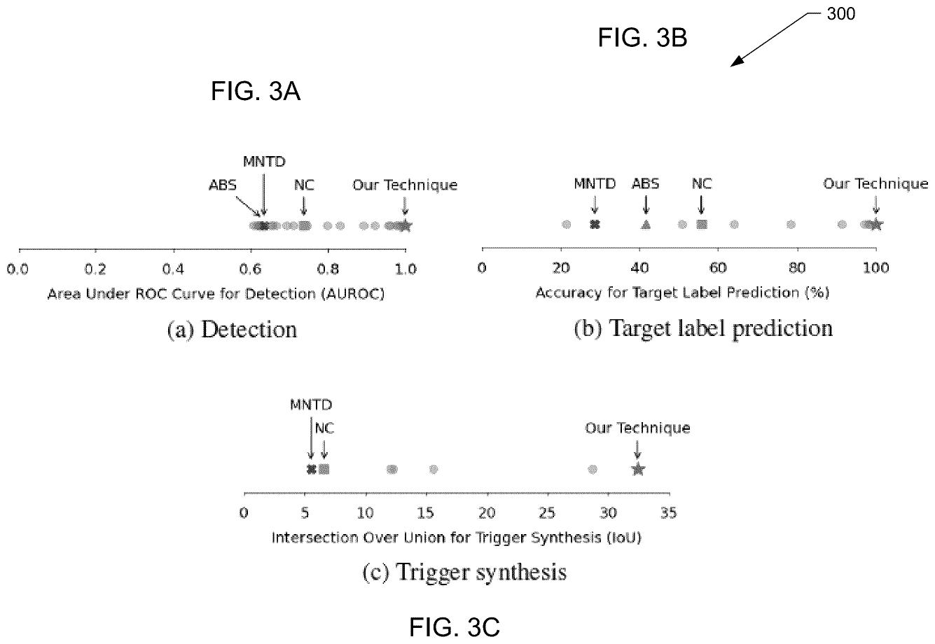

FIG. 3 shows a comparison of performance across the three tasks in the NeurIPS 2022 Trojan Detection Challenge 300. Baseline techniques are marked in color, competition submissions are marked in grey, and the proposed technique is marked in green. The proposed technique outperforms all other models in all three tasks. Please note that most baselines were not limited by black-box and zero-shot settings. Competition models were allowed to use a different algorithm for each task, dataset and Trojan attack type. Details of limitations are presented in Table 1.

FIGS. 3A-C demonstrate that the proposed technology technique outperforms the three baselines and all the TDC submissions. Notably, this achievement is even more remarkable considering that the proposed technology technique operates solely within the constraints of a black-box and zero-shot defense setting. In contrast, ABS and Neural Cleanse require white-box access, while MNTD and top-scoring TDC submissions heavily rely on learning (i.e., requiring labeled clean and Trojan models for training and validation). Furthermore, the top-scoring TDC submissions employ distinct approaches for each dataset and model architecture. In contrast, the proposed technology stands out as a single executable code that remains agnostic to the dataset and architecture.

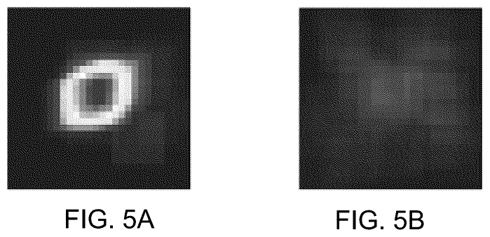

FIG. 5 shows a heatmap of patch triggers synthesized for clean CNNs trained on MNIST 500. Synthesized patches are densely located in the central portion of the image. This is because in MNIST, the primary image content-the digit, is located in the center of the image. Despite being clean, a model can misclassify a digit when a large portion of it is covered by a patch, making it look like another digit. Thus, clean models find most generated patches located in the center and covering up the primary image content. FIG. 5 also shows a heatmap of patch triggers synthesized for Trojan CNNs train on MNIST 505. Synthesized triggers for Trojan models are dispersed throughout the image. This is expected as trigger locations, shape, and size are randomly selected for each Trojan model.

Analyzing errors in the proposed technology results for each model architecture/image dataset and attack type (see FIG. 4), it is shown that the proposed technology achieves perfect AUROC for detecting all blended attacks. This is because the search space for blended attacks is continuous and thus easier to search. On the other hand, the search space for patch attacks is combinatorial and, therefore, harder. The proposed technology achieves perfect AUROC for detecting Wide ResNets trained on CIFAR-10/CIFAR-100 and ViTs trained on GTSRB. However, the proposed technology AUROC drops from 1.0 to 0.92 for patch-attacked CNNs trained on MNIST.

The drop in performance for patch-attacked CNNs is due to the simplicity of the images contained in the MNIST data and used to train the CNNs. They are small (28×28 pixels), gray-scale, and contain simple features that compose hand-written digits. Consequently, it is easy to generate a trigger covering a part of the digit with a simple pattern that makes it look like a different one.

FIG. 5A depicts a heatmap produced by overlaying all synthesized triggers of clean models and showing where these triggers are located within the image's dimensions. FIG. 5B shows the same information for Trojan models. In FIG. 5A, it is shown most synthesized triggers of clean models are located in the dense central portion of the image, sharing the same shape and size. This is because the central portion of the image contains the main content-the digit. Covering up a portion of the digit with a simple pattern can easily change the model's classification output (e.g., adding a horizontal line to the middle of a 0 turns it into an 8). This existence of ‘natural Trojans’ in clean models, with none of the existing solutions being capable of discerning these ‘natural Trojans’ from injected Trojans has been previously identified in the literature.

In contrast, FIG. 5B shows that synthesized triggers of Trojan models are dispersed across the image space and have diverse shapes and sizes. This is expected as trigger locations, shapes, and sizes are distinct for each Trojan attack. Altogether, the proposed technology successfully generates patch triggers for Trojan CNNs trained on MNIST. However, due to the aforementioned phenomena, it also successfully generates patch triggers for clean CNNs trained on MNIST. The result is a higher rate of false positives and the observed drop in AUROC for detection.

Hyper-parameter Analysis—the hyper-parameters of the proposed technology are analyzed: the batch size b of the clean image validation set, the number of steps s used in the proposed technology search algorithm, and the smoothing parameter λ used in the proposed technology scoring function. Due to the computational and time costs of running the entire dataset of models, results on 45 models selected for hyper-parameter analysis are reported via stratified random sampling.

For analyzing the time efficiency of the proposed technology algorithm, the execution time for each label is reported. The proposed technology is embarrassingly parallelizable. First, the algorithm can be run for each label in parallel. Second, the majority of the runtime is used to compute the cASR at each step. This can also be parallelized by distributing the inputs used to compute the cASR to different GPUs for simultaneous processing.

FIG. 6 shows an analysis of the impact of clean image validation batch size (b), number of executed optimization steps (s), and cASR approximation parameter (λ) on the proposed technique's detection performance.

Batch size refers to the number of clean validation images used to compute the cASR. The proposed technology varies b∈ {1, 16, 32, 64, 128, 256}, recording detection performance and the algorithm's execution time for each label. FIG. 6A shows that the execution time increases rapidly as b increases, as each computation of the cASR requires passing a larger number of images to the GPU. However, increasing b also leads to improvements in the detection AUROC due to the cASR becoming a better sample of the ASR, which is computed on the entire dataset. Only a small batch size is needed in the proposed technology approach (<0.01% of the entire dataset). This set of images can be realistically obtained by a user wishing to validate the performance of their model.

Number of steps employed in the proposed technology search is varied for s∈{1 k, 5 k, 10 k, 25 k, 50 k, 75 k}. Each step constitutes altering the trigger pattern or the trigger mask (i.e., trigger location, shape, or size). FIG. 6B demonstrates that running for a greater number of steps leads to improved results in detection, with a linear relationship between n and the execution time of each label.

λ parameter controls the smoothing when approximating cASR from the model's output on the proposed technology batch of validation images. The proposed technology varies λ∈ {0.1, 0.6, 1.1, 1.5, 2.1, 2.6, 3.1, 3.6, 4.1, 4.6}, observing from FIG. 6C that λ=0.6 achieves optimal detection performance. Smaller values of λ approximate the ASR too closely, making the scoring function discrete and preventing the generative process from identifying good changes at each step. Larger values of λ approximate the ASR too loosely. Thus, the generative process converges towards triggers with misleadingly high cASR but low ASR.

### Supplementary Material

TABLE 3
Information on image datasets used to train clean and Trojan models

| | Image | | # of | Training | Test |
|---|---|---|---|---|---|
| Dataset | Size | Color | Labels | Set Size | Set Size |
| CIFAR-10[26] | 32 × 32 | RGB | 10 | [symbol] | 10,000 |
| CIFAR-100[26] | 32 × 32 | RGB | 100 | [symbol] | 10,000 |
| GTSRB[28] | 32 × 32 | RGB | 4 [symbol] | [symbol] | 12,630 |
| MNIST[25] | 28 × 28 | Grey [symbol] scale | 10 | [symbol] | 10,000 |

[symbol]

indicates data missing or illegible when filed

Information on architectures of clean and Trojan models

| | Number of | Number |
|---|---|---|
| Architecture | Parameters | of Layers |
| [symbol] Neural Network (CNN) | 227,338 | 5 |
| Wide Residual Network(Wide ResNet) [27] | 2,255,156 | 38 |
| Vision Transformer (VIT) [29] | 3,556,395 | 26 |

[symbol]

indicates data missing or illegible when filed

TABLE 5
CLassification accuracy and ASR of clean and Trojan models

| | Trojan Models | | Clean Models |
|---|---|---|---|
| Dataset | Classifictaion Accuracy | ASR | Classification Accuracy |
| CIFAR-10 | 93.89% | 98.62% | 93.94% |
| CIFAR-100 | 74.54% | 99.79% | 74.64% |
| GTSRB | 84.12% | 99.24% | 84.18% |
| MNIST | 99.24% | 99.04% | 99.26% |

Discussion of Neural Trojan Attacks—A large and diverse set of highly effective Trojan backdoor attacks have been studied. The vast majority of these approaches consider data poisoning attacks, where the attacker adds the trigger to a small subset of the training data and then injects this trigger into the model via training. Model poisoning is the other major attack type, where the adversary modifies the training algorithm for a small subset of neurons and thus directly injects the trigger into the model.

Various works have developed stealthier attacks by making the trigger visually indistinguishable, less predictable, and more resilient, while other works aimed to minimize the attack footprint on the model. Research has demonstrated the practical feasibility of these attacks in the physical world and domains beyond images, including video, text, and graphs. Finally, attacks have been successfully deployed across various machine learning techniques and models, including RNNs, autoencoders and GANs, federated learning, reinforcement learning, and transfer learning.

Neural Trojan Attack Configuration—For patch attacks, the entries of the pattern matrix p are randomly sampled from an independent Bernoulli 0/1 distribution. The mask matrix m is distinct for each Trojan model, meaning each trigger has a different location and size. For blended attacks, the entries of the pattern matrix p are randomly sampled from an independent Uniform (0, 1) distribution. All attacks are all-to-one (i.e., misclassifying samples from all classes to a single target class t), with a random choice of t.

In this disclosure, a Trojan detection technique that operates under an extensive set of restrictions imposed in realistic defense settings is presented. The proposed technology is developed to perform detection, as well as predict the target label and generate the trigger used in the attack. The proposed technology's performance on these tasks for patch and blended attacks is evaluated, comparing against three widely recognized baselines, as well as all submissions made to the NeurIPS 2022 Trojan Detection Challenge. Despite being free from the restrictions imposed on the proposed technology, the baselines and competition submissions are all outperformed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for zero-shot black-box detection of neural Trojans comprising:
a server;
a processor;
memory storing instructions, which when executed by the processor, cause the processor to apply a zero-shot black-box detection of neural Trojans algorithm.

2. The system of claim 1, wherein the zero-shot black-box detection of neural Trojans algorithm is:

| | |
|---|---|
| 1: | X ← random Trigger( ) |
| 2: | for k = 1, . . . , s do |
| 3: | $T ← ϵ \cdot ( \frac{1}{\text{?} + \text{?}} - \frac{1}{\text{?} + \text{?}} )$ $\text{?} \text{indicates text missing or illegible when filed}$ |
| 4: | X_{new} ← randomNeighbor(X) |
| 5: | C_{old} ← cASR(X) |
| 6: | C_{new} ← cASR(X_{new}) |
| 7: | Δ_{C} ← C_{new} − C_{old} |
| 8: | if Δ_{C} > 0 then |
| 9: | X ← X_{new} |
| 10: | $else if {e}^{\frac{{Δ}_{C}}{T}} \geq random ( 0 , 1 ) then$ |
| 11: | X ← X_{new} |
| 12: | end if |
| 13: | end for |

3. A method of using zero-shot black-box detection of neural Trojans comprising:
receiving a patch;
performing simulated annealing on the patch using a zero-shot black-box detection of neural Trojans algorithm;
detecting the presence of a Trojan.

4. The method of claim 3, wherein the patch includes at least one of a random pattern, a size, a shape, or a location.

5. The method of claim 4, wherein the zero-shot black-box detection of neural Trojans algorithm is:

| | |
|---|---|
| 1: | X ← random Trigger( ) |
| 2: | for k = 1, . . . , s do |
| 3: | $T ← ϵ \cdot ( \frac{1}{\text{?} + \text{?}} - \frac{1}{\text{?} + \text{?}} )$ $\text{?} \text{indicates text missing or illegible when filed}$ |
| 4: | X_{new} ← randomNeighbor(X) |
| 5: | C_{old} ← cASR(X) |
| 6: | C_{new} ← cASR(X_{new}) |
| 7: | Δ_{C} ← C_{new} − C_{old} |
| 8: | if Δ_{C} > 0 then |
| 9: | X ← X_{new} |
| 10: | $else if {e}^{\frac{{Δ}_{C}}{T}} \geq random ( 0 , 1 ) then$ |
| 11: | X ← X_{new} |
| 12: | end if |
| 13: | end for |
